(19) United States
(12) Patent Application Publication
(10) Pub. No.: US 2005/0171816 A1
(43) Pub. Date: Aug. 4, 2005

(54) Substance abuse management system and method

(76) Inventors: Edward Francis Meinert, New York, NY (US); Fredrick Jerrell Schivers, New York, NY (US); Michael Stuhlmiller, Upper Montclair, NJ (US); John F. Thomas, Anna Maria, FL (US); Simon Barker, Farnham Surrey (GB)

Correspondence Address: SCHWEGMAN, LUNDBERG, WOESSNER & KLUTH, P.A., P.O. BOX 2938, MINNEAPOLIS, MN, 55402-0938, US

(21) Appl. No.: 10/827,618

(22) Filed: Apr. 19, 2004

Related U.S. Application Data
(60) Provisional application No. 60/541,659, filed on Feb. 4, 2004.

(51) Int. Cl. G06F 17/60

(52) U.S. Cl. 705/3

(57) ABSTRACT

A method of managing correctional and/or rehabilitation programs for substance abuse for a number of entities having jurisdictional responsibility for persons, the method comprising: receiving correctional and/or rehabilitation data from a plurality of entities having jurisdictional responsibility for persons, said correctional and/or rehabilitation data including information on substance abuse by persons for which said entities have jurisdictional responsibility; processing the received correctional and/or rehabilitation data to aggregate the data and reference the data by each entity to allow for comparative analysis of the correctional and/or rehabilitation programs; storing the processed correctional and/or rehabilitation data in a central database; and managing the correctional and/or rehabilitation programs dependant upon the processed data.

### RELATED APPLICATIONS

This application claims priority under 35 U.S.C. § 119(e) to U.S. Provisional Patent Application No.: 60/541,659 filed Feb. 4, 2004, which application is incorporated herein by reference.

### FIELD OF THE INVENTION

The present invention relates to the management of substance abuse programs for persons who are the subject of a jurisdictional responsibility of a jurisdictional responsible entity.

### BACKGROUND OF THE INVENTION

Substance abuse has become a problem throughout society in general but has become a particular problem in the judicial system where people who are the jurisdictional responsibility of some jurisdictional entity are required by law to be monitored and tested. Jurisdictional responsibility for persons can reside in any type of jurisdictional entity. One type of jurisdictional entity comprises judicial entities, e.g., courts, magistrates, etc. Another type of jurisdictional entity comprises custodial institutions that have custodial responsibility for persons in their custody, e.g., prison authorities and/or police. Other jurisdictional entities having jurisdictional responsibility include parole boards and probation authorities. The jurisdictional entities can be comprised of one or more individuals, e.g., a judge, prison wardens, parole board members, etc. For example, a person convicted by a court of law or pending trial held in custody in correctional institutions must be the subject of a controlling substance abuse program in order to control the prevalence of substance abuse in the correctional institution. Also special ‘drugs courts’ have been set up to administer justice to substance abusers and have the power to hand down sentences including the requirement for the person to undergo rehabilitation during which their drug taking habits must be monitored. Any deviation from the behaviour decreed by the sentence needs to be detected and can be appropriately punished. This requires a substance abuse program for the persons who are the judicial responsibility of the drugs courts. Further, it can be made the condition of the parole of a person released from prison or a person put on probation that they do not subject themselves to substance abuse. This requires a substance abuse program.

In the past, some substance abuse programs have been managed on an ad hoc basis with no central coordination. Each authority having judicial responsibility for persons operates their own programs. This leads to inconsistency and does not allow the coordination of the programs or the ability to compare the effectiveness of the programs. It further does not allow for the clear identification of substance abuse trends and to enable targeted testing of persons based on a broader base of substance abuse information.

Another requirement of the substance abuse programs is the accurate and accountable taking of substance abuse tests. If a person fails a test, this can have serious legal repercussions for the person. For example, it can lead to them having their parole or probation rescinded thus causing the person to be incarcerated. The tests are thus required to have a ‘chain of custody’ associated with them which includes information associated on the process from the taking of the test to the analysis of the test to show the persons responsible for the testing, analysis, and any steps in between (e.g. storage and carriage) and all required legal information to prove the validity of the test and the result of the analysis to a standard sufficient to stand up as evidence in a court of law.

Substance abuse tests can comprise two types, namely, laboratory tests and instant tests. Traditionally substance abuse tests required the taking of a sample from the person and the analysis of the sample in a laboratory. The need for and the use of the recording of the chain of custody for such tests is well established. Recently, with the progress in the field of instant substance abuse tests, the use of such tests has become far more prevalent since they offer the benefit of an instant result. They are also becoming less expensive. This is an important factor in a mass substance abuse program for entities having jurisdictional responsibility for a large number of persons. Because these test are instant, the requirement for a full chain of custody record that will provide information on the circumstances surrounding the instant test has not been recognised.

An aspect of the present invention is to provide an improved substance abuse system and method, which can address the deficiencies in the prior art.

### SUMMARY OF THE INVENTION

A first aspect of the present invention provides a method and system for managing correctional and/or rehabilitation programs for substance abuse for a number of entities having jurisdictional responsibility for persons. The method comprises receiving correctional and/or rehabilitation data from a plurality of entities having jurisdictional responsibility for persons, said correctional and/or rehabilitation data including information on substance abuse by persons for which said entities have jurisdictional responsibility; processing the received correctional and/or rehabilitation data to aggregate the data and reference the data by each entity to allow for comparative analysis of the correctional and/or rehabilitation programs; storing the processed correctional and/or rehabilitation data in a central database; and managing the correctional and/or rehabilitation programs dependant upon the processed data.

Thus in accordance with this aspect of the present invention, the correctional and/or rehabilitation data from a plurality of entities can be combined to provide a number of benefits.

In one embodiment the correctional and/or rehabilitation programs are managed to standardize the programs for the entities.

In one embodiment the management of the program includes determining what drug to test for and when to test based on the processing.

In one embodiment the management of the program includes identifying a group of persons and determining what drug to test for and when to test based on the processing.

In one embodiment the processing includes processing the storing the received correctional and/or rehabilitation data to determine recidivism rates for persons.

In one embodiment the management of the program includes determining random drug test programs.

In one embodiment the database stores a test history for each person, indexed by entity. The test history for each person can include information on a current entity having jurisdictional responsibility and any previous entities having jurisdictional responsibility.

In one embodiment the management of the correctional and/or rehabilitation programs includes identifying the substance to test for and the equipment to use for the test.

In one embodiment the entities having jurisdictional responsibility are organized in at least one hierarchy, and the data is stored in the database in a jurisdictional hierarchical structure. For example, institutions in a county and within a state can be organised in a hierarchical structure. Also persons having jurisdictional responsibility can be arranged hierarchically, e.g., individual prison wardens, prison wardens responsible for a wing in a prison, and prison governors responsible for prisons can be arranged hierarchically.

In one embodiment the management of the correctional and/or rehabilitation programs includes generating reports on the processed correctional and/or rehabilitation data.

In one embodiment the management of the correctional and/or rehabilitation programs includes performing statistical analysis on the processed correctional and/or rehabilitation data.

The entities can include at least one of: individual or groups of correctional institutions, individual or groups of parole authorities, individual or groups of probation authorities, individual or groups of courts, and police. The entities can also include individuals such as prison wardens prison governors, and groups of individuals.

The persons can include at least one of: correctional institution inmates, parolees, remanded persons, probationers, and detainees.

Another aspect of the present invention provides a method and apparatus for forming a chain of custody record for instant drug tests for persons. Point-of-test information is obtained at times instant drug tests are taken, the point-of-test information including information on the circumstances surrounding the taking of a drug tests. Results of the instant drug tests are obtained and the point-of-test information is stored in conjunction with the results to provide a chain of custody record for the instant drug test for each person.

Thus this aspect of the present invention provides a means by which a chain of custody record can be generated for an instant test, which will stand the evidential test in a court of law.

In one embodiment a biometric measurement is obtained from each person at the time the instant drug test is performed, wherein the point-of-test information for each person includes the biometric information obtained from the person. This enables the identity of the person who took the test to be confirmed with centrally stored biometric information for the persons. This confirms the validity of the test and avoids the possibility of persons using other persons to take the test on their behalf in order to avoid drug abuse detection.

In one embodiment the point-of-test information for each person includes information on the test equipment, information on the tester, information on the test environment, and test location, date and time information.

In one embodiment image information is obtained for the test, wherein said information on the test environment includes the image information for the test. The image information can comprise an image of the test environment and can include an image of the test result when this is a visible result from equipment. For example, the image can be an image of the tested person in the test environment and it can include an image of a test ‘stick’ showing the color of the ‘stick’ to indicate the test result.

In one embodiment the image information comprises a still or motion image of the test equipment showing the test result and the tested person in the test environment.

The information on the test environment can include temperature, humidity; light level, noise level, air pressure etc. The information on the tester can include personal details, experience, and physical fitness parameters such as sight, and hearing.

Another aspect of the present invention provides apparatus for recording test information for forming a chain of custody record for instant drug tests for persons. The apparatus comprises a camera component for taking still or motion pictures of the test conditions; a biometric recorder component for taking a biometric measurement of the tested persons; an input interface for the input of test information including test results; a memory for storing the test information, the pictures and the biometric measurements as chain of custody record records; and an output interface for transmitting the stored information to a remote computer apparatus for recordal of the chain of custody records.

Thus this aspect of the present invention provides a means to facilitate the generation of a chain of custody record for an instant test in which information on the circumstances surrounding the test can be recorded by way of an image, together with the test result and biometric information to allow for the confirmation of the identity of the person being tested.

Another aspect of the present invention provides apparatus for forming a chain of custody record for instant drug tests for persons, the apparatus comprising: a camera component for taking still or motion pictures of the test conditions at times instant drug tests are taken; a biometric recorder component for taking biometric measurements of the tested persons; an input interface for the input of test information including results of the instant drug tests; and a storage device for storing the still or motion pictures, the biometric measurements, and the results to provide a chain of custody record for the instant drug test for each person.

Another aspect of the present invention provides a system and method which uses a flexible object oriented data model for a correctional and /or rehabilitation program for substance abuse which allows for the formation and management of a hierarchical management structure encompassing the concept of custodianship.

In this aspect a database stores substance abuse data for a plurality of persons. The data comprises substance abuse results data, data on persons, data on users of the system, and data on hierarchical relationships of the users. A database interface allows the input of data to and the output of data from the database. The database interface comprises code structured to operate in accordance with an object oriented data model in which data is represented as objects. The objects include substance abuse results objects defining information on substance abuse results for persons, person objects defining information on persons, users and/or location objects defining information on system users comprising custodians of said persons and/or information on custodial locations of said persons, and organization objects defining information on at least one hierarchical relationship of said system users and/or locations of said persons. The at least one hierarchical relationship defines at least one custodial hierarchy for custodianship of said persons. The object oriented data model allows for the formation and management of the at least one hierarchical relationship to provide for the formation and management of said at least one custodial hierarchy for said persons.

In one embodiment, the database interface code is structured to allow for the independent modification of any said object.

In one embodiment, the database interface code is structured to allow for the formation and management of at least one further hierarchical relationship defining at least one jurisdictional hierarchy for jurisdictional responsibility for said users and said persons. In this embodiment, the concept of jurisdiction encompasses the responsibility an entity has not just for offenders, but also for the custodians responsible for administering custody to the offenders. Such entities can be for example correctional institutions that have both inmates and officers within their jurisdictional responsibility, parole boards who have paroled persons and parole officers within their jurisdiction, drug courts that have offenders and court officers within their jurisdiction.

Although the aspects of the invention described above can be used independently, they can also be used together in any combination.

The aspects of the present invention can also be implemented in a computer system using software. Thus the present invention encompasses computer program code for controlling a computer to carry out the methodology described above. The computer program code can be provided to a computer on any suitable carrier medium. Such a medium can be a transient medium, i.e. a signal such as an electrical, optical, magnetic, acoustic, microwave, RF, or electromagnetic signal. One such an example is a signal transmitted over an electronic network such as a computer network, which can include a global computer network such as the world wide web and the Internet. Such networks are adapted to carrying the computer code. The carrier medium can also be a storage medium such as a magnetic medium (e.g. a floppy disk, hard disk, or tape), an optical medium (e.g. a CD ROM or DVD), or a solid-state memory device such as ROM, EPROM, EEPROM or Flash memory.

### BRIEF DESCRIPTION OF THE DRAWINGS

FIG. 1 is a schematic diagram of a substance abuse management system in accordance with one embodiment of the present invention;

FIG. 2 is a schematic diagram of a device for acquiring substance abuse test data, information on the circumstances surrounding the substance abuse tests, and biometric measurements of the tested person in accordance with one embodiment of the present invention;

FIG. 3 is a diagram illustrating the data model used in accordance with one embodiment of the present invention;

FIG. 4 is a diagram of the Employees table in the data model of FIG. 3;

FIG. 5 is a diagram of the Emp_Phone table in the data model of FIG. 3;

FIG. 6 is a diagram of the Emp_IDCode_Type table in the data model of FIG. 3;

FIG. 7 is a diagram of the Emp_Address table in the data model of FIG. 3;

FIG. 8 is a diagram of the Employee_Prefs table in the data model of FIG. 3;

FIG. 9 is a diagram of the Emp_IDCodes table in the data model of FIG. 3;

FIG. 10 is a diagram of the Ik_Address_Type table in the data model of FIG. 3;

FIG. 11 is a diagram of the lk_Country table in the data model of FIG. 3;

FIG. 12 is a diagram of the Emp_Jobs table in the data model of FIG. 3;

FIG. 13 is a diagram of the Job_Stats table in the data model of FIG. 3;

FIG. 14 is a diagram of the Jobs table in the data model of FIG. 3;

FIG. 15 is a diagram of the Client_Prefs table in the data model of FIG. 3;

FIG. 16 is a diagram of the Clients table in the data model of FIG. 3;

FIG. 17 is a diagram of the TPA_Client_Map table in the data model of FIG. 3;

FIG. 18 is a diagram of the Client_Products table in the data model of FIG. 3;

FIG. 19 is a diagram of the Products table in the data model of FIG. 3;

FIG. 20 is a diagram of the Locations table in the data model of FIG. 3;

FIG. 21 is a diagram of the Reports table in the data model of FIG. 3;

FIG. 22 is a diagram of the Functions table in the data model of FIG. 3;

FIG. 23 is a diagram of the Function_Types table in the data model of FIG. 3;

FIG. 24 is a diagram of the Security_Access table in the data model of FIG. 3;

FIG. 25 is a diagram of the Groups table in the data model of FIG. 3;

FIG. 26 is a diagram of the Permissions table in the data model of FIG. 3;

FIG. 27 is a diagram of the User_Groups table in the data model of FIG. 3;

FIG. 28 is a diagram of the Users table in the data model of FIG. 3;

FIG. 29 is a diagram of the User_Prefs table in the data model of FIG. 3;

FIG. 30 is a diagram of the User_Org_Nodes table in the data model of FIG. 3;

FIG. 31 is a diagram of the Exam_Review table in the data model of FIG. 3;

FIG. 32 is a diagram of the Exams table in the data model of FIG. 3;

FIG. 33 is a diagram of the Exam_Params table in the data model of FIG. 3;

FIG. 34 is a diagram of the Def_Parameters table in the data model of FIG. 3;

FIG. 35 is a diagram of the Categories table in the data model of FIG. 3;

FIG. 36 is a diagram of the Def_Exam_Profiles table in the data model of FIG. 3;

FIG. 37 is a diagram of the Def_Exam_Types table in the data model of FIG. 3;

FIG. 38 is a diagram of the Random_Pools table in the data model of FIG. 3;

FIG. 39 is a diagram of the Org_Nodes table in the data model of FIG. 3;

FIG. 40 is a diagram of the Org_Treewalks table in the data model of FIG. 3;

FIG. 41 is a diagram of the Org_Trees table in the data model of FIG. 3;

FIG. 42 is a diagram of the Org_Unit_Types table in the data model of FIG. 3;

FIG. 43 is a diagram of the Org_Units table in the data model of FIG. 3;

FIG. 44 is a diagram of the Cron_Params table in the data model of FIG. 3;

FIG. 45 is a diagram of the Cron_Jobs table in the data model of FIG. 3;

FIG. 46 is a diagram of the Audit table in the data model of FIG. 3;

FIG. 47 is a diagram of the Cron_logs table in the data model of FIG. 3;

FIG. 48 is a diagram of the Help_Pages table in the data model of FIG. 3;

FIG. 49 is a diagram of a screen shot provided by the system according to one embodiment of the present invention to allow a user to enter a persons name or ID to search for substance abuse test results for the person;

FIG. 50 is a diagram of a screen shot provided by the system showing the results of the search;

FIG. 51 is a diagram of a screen shot provided by the system showing the test results for a person;

FIG. 52 is a diagram of a screen shot provided by the system showing detailed information on a test result;

FIG. 53 is a diagram of a screen shot provided by the system allowing a user to enter a test result;

FIG. 54 is a diagram of a screen shot provided by the system showing the form for entry of test results;

FIG. 55 is a diagram of a screen shot provided by the system allowing a user to select criteria for random tests to be displayed;

FIG. 56 is a diagram of a screen shot provided by the system showing the random test results for the criteria selected in FIG. 55;

FIG. 57 is a diagram of a screen shot provided by the system allowing a user to specify criteria for performance reports;

FIG. 58 is a diagram of a screen shot provided by the system showing the tests meeting the search criteria input in FIG. 57;

FIG. 59 is a diagram of a screen shot provided by the system showing the statistics regarding the number of tests performed based on the criteria entered in FIG. 57;

FIG. 60 is a diagram of a screen shot provided by the system showing tests cancellation statistics for test meeting the criteria of FIG. 57;

FIG. 61 is a diagram of a screen shot provided by the system showing the percentages of tests where laboratory analysis does not confirm the instant test results;

FIG. 62 is a diagram of a screen shot provided by the system allowing the user to specify criteria for displaying statistical reports related to drug user patterns;

FIG. 63 is a diagram of a screen shot provided by the system shows various views of positive rates for drugs;

FIG. 64 is a diagram of a screen shot provided by the system showing positive test data for individuals;

FIG. 65 is a diagram of a screen shot provided by the system allowing a user to specify search criteria in order to display a list of inmates/parolees associated to a particular officer; and

FIG. 66 is a diagram of a screen shot provided by the system showing a list of individuals assigned to an officer based on the search criteria selected in FIG. 65.

### DETAILED DESCRIPTION OF SPECIFIC EMBODIMENTS OF THE PRESENT INVENTION

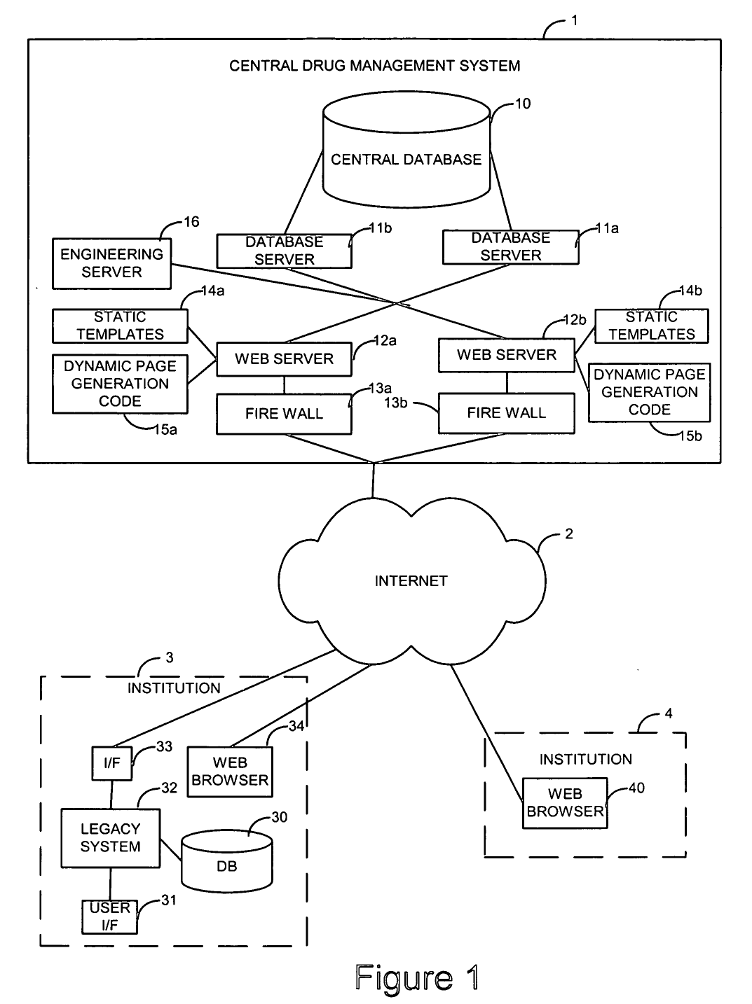

FIG. 1 is a schematic diagram of a system in accordance with one embodiment of the present invention. A central drug management system 1 is connected over a network such as the Internet 2 to a first correctional institution 3 and a second correctional institution 4.

The first correctional institution 3 comprises an institution operating a substance abuse program for persons. The correctional institution can be any entity having jurisdictional responsibility for persons, such as a prison or department of correction comprising a number of prisons or similar institutions. Thus the institution is not limited to one geographical institution and can comprise an aggregated number of institutions operated by one institutional entity. The first correctional institution 3 includes a legacy system 32 comprising their own internal system for collecting, processing and managing substance abuse data to implement their own substance abuse program. The legacy system 32 comprises a computer system interfaced to a database 30 storing the substance abuse program data. The legacy system can also include a human resource system for managing employed persons having jurisdictional responsibility for the persons being monitored by the substance abuse program. These employed persons can comprise prison officers, parole officers, court officials, and remand officials for example. The legacy system 32 includes a user interface 31 to allow users of the legacy system to interface with the system to enter and view data.

A communications interface 33 is provided to the central drug management system 1 over the Internet 2 to upload data into the central drug management system 1 and also to download data there from. Conveniently the uploading can be performed using known protocols such as File Transfer Protocol (FTP). The communications over the Internet 2 are made using known secure means such as using the Secure Sockets Layer (SSL) Protocol or using other forms of encryption. For convenience the uploading of data to the central drug management system 1 can take place at times when the legacy system 32 is quiescent, e.g., overnight. The uploaded data can then be assimilated into the central database 10. This can be achieved by identifying the parameters that have changed and updating these parameters in the central database 10.

The first institution 3 thus keeps its own substance abuse program data and also uses the central drug management system 1 to provide for standardization and comparison of substance abuse programs. In this scenario the direction of data transfer is primarily towards the central drug management system 1.

The first institution is provided with a web browser 34 to allow access to information stored on the central drug management system 1. This allows users at the first institution 3, e.g., prison officers, to view substance abuse data available at the central drug management system 1.

The second institution 4 is provided only with a web browser 40 to allow users at the second institution access to substance abuse data stored at the central drug management system 1. In this scenario, the second institution 4 does not maintain their own substance abuse data on their own computer system Instead they utilise the central drug management system 1 for all their substance abuse program needs. The web browser 40 enables them to access web pages enabling substance abuse test data to be entered. These are processed and can be viewed together with more global substance abuse information for many institutions to enable standardisation and comparison. The communication between the web browser 40 and the central drug management system 1 is secured using known secure communications protocol such as the SSL.

The central drug management system 1 comprises a redundant system of two firewalls 13a and 13b connected to the Internet 2 and two web servers 12a and 12b. The web servers 12a and 12b are Apache web servers running Perl scripts and JavaScript and use stored static HTML templates 14a and 14b and dynamic page generation code 15a and 15b. The Apache servers also use Mason (Trade Mark) to allow mix of Perl and HTML to be used. Redundant database servers 11a and 11b are provided for accessing data in a central database 10. The database servers in this embodiment use Microsoft (Trade Mark) SQL Server 2000. An engineering server 16 is provided to allow for maintenance etc.

The central database 10 stores all of the substance abuse program management data for a number of entities in a flexible data structure, which allows users to define and modify the client's organizational structure. The data structure will be described in more detail hereinafter.

The use of a central repository for substance abuse program data from a plurality of entities enables the global processing of the substance abuse data to enable the data to be compared and standardised. Thus substance abuse programs can be standardized for entities and the results compared. This is important since the effectiveness of rehabilitation programs need to be measured to determine their effectiveness. This can only be done with some degree of reliability by comparing results between programs. For example, in the US drug courts are being set up to deal with persistent drug users. They have the power to hand out sentences allowing the offender to stay in the community in return for participating in a drug rehabilitation program, which includes being regularly monitored to detect recidivism. The effectiveness of these courts needs to be measured in order to enable the justification of their existence and the justification of the expense of the rehabilitation programs.

The generation of a central database of drug test results for a plurality of entities also allow for the processing of the data to facilitate the identification of trends in substance abuse that can transcend entities and can help to identify a potential trend in the community. This will assist the entities such as the correctional institutions and drug court to modify their substance abuse programs to take the trends into consideration.

One feature that is important in substance abuse programs is the establishment of a chain of custody for all substance abuse tests. The chain of custody is a legal requirement for substance abuse test data to be admissible in a court of law. The chain of custody must establish beyond reasonable doubt that the test was taken by an identified person. The date and time of the test and the result of the test must be recorded. Information on the tester and the test that was performed must be recorded. What processing of the test sample was performed by a laboratory, by whom and when must be recorded. Also a secure method of handling samples must be provided for. Methods for the establishment of the chain of custody for laboratory-generated results exist. All this data is recorded in the central database.

In this embodiment of the present invention a method of establishing a chain of custody for instant test results is provided. Instant test results are becoming more prevalent due to the advancement of science in the field which has resulted in more reliable instant test products being available and at a lower cost. Instant test thus have the advantage of simplifying the testing procedure in a substance abuse program. The results are available immediately often at a lower cost than laboratory tests. This immediacy avoids the cost of sample gathering and secure transportation to comply with the chain of custody requirements. Also the need for the gathering of additional data associated with laboratory tests such as identifying the tester, the time of the test, the test process, etc. is avoided. Of course, as a backup to support a positive instant test, a laboratory test can be performed to confirm the result. However since this is only performed for positive instant tests, the additional burden is low.

Instant tests often take the form of products such as test sticks that require a saliva or urine sample from the patient. These are non-invasive tests. Blood may also be used in instant test but this does require a phlebotomist to be present. The chain of custody requirement requires that the test results be recorded in a manner that is beyond reasonable doubt. In this embodiment, information on the circumstance surrounding the test result is recorded in addition to the test result. The test result can simply be the entering of a reading from a piece of reading equipment e.g. reading the color of a test stick. In order to avoid the need to store the test product in case the result is later contested and since in many cases the test product is not stable enough to store for any period of time, an image of the test result product can be recorded. Also or alternatively an image can be taken of the environment during the test. For example, the image can be of the person subject to the test in the test surroundings e.g. the test room. Further, other test environment information can be recorded manually or automatically such as temperature, humidity, air pressure, noise level, ambient light conditions, persons present during test other circumstantial information surrounding the test such as person's behaviour or medical condition. This information is all stored with the test result to for the chain of custody record.

In this embodiment another problem in the prior art is addressed. When a person is required to give a test, they can sometimes try to get someone else to take the test for them in order to avoid substance abuse detection. Thus in this embodiment of the present invention a biometric measurement of the person taking the test is taken at the time of the test and this is stored with the test data as part of the chain of custody data. It can later be compared with biometric data stored in the central database to confirm the validity of the test. This further enhances the standing of the chain of custody for the test.

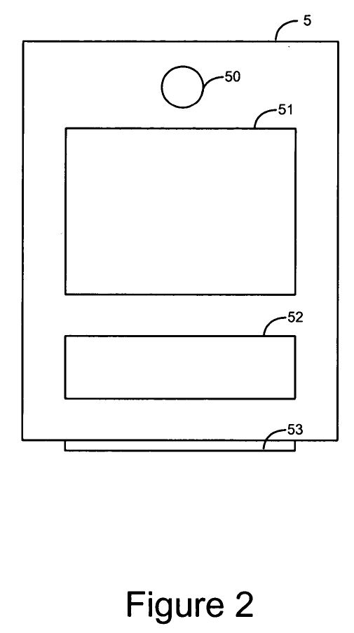

FIG. 2 is a diagram of a portable device for use during a substance abuse test to record test circumstance information and biometric information for the chain of custody data. The device 5 can be in the form of a personal digital assistant (PDA) with a user input region 52 for the input of test result information by the tester. A region 51 is provided for placement of a finger of the person being tested to obtain a biometric measurement in the form of a fingerprint. A camera lens 50 is provided for the taking of images (either still or motion) of the test surroundings, the person being tested and/or the test product. All of the information entered is stored in memory within the device 5. The device is also provided with an interface 53 for interfacing with a computer to upload the information. The computer can comprise any conventional computer used by an institution and connected to the central drug management system 1 over the Internet 2. The interface can comprise any conventional wire or wireless interface for communication to the computer.

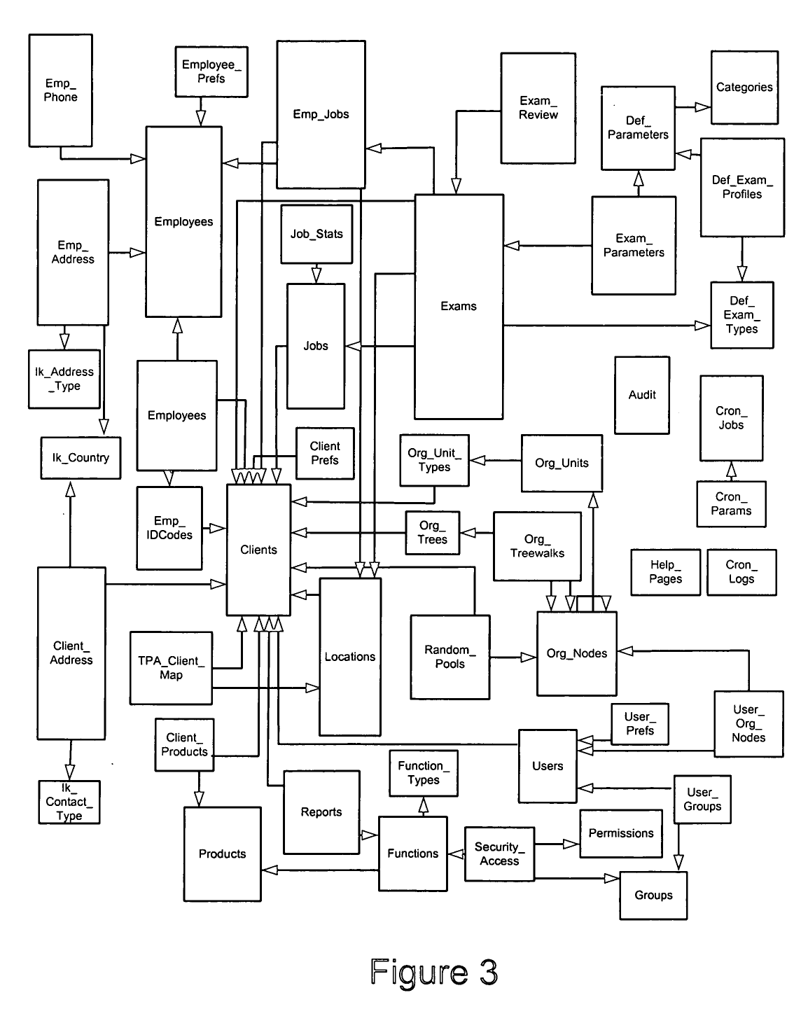

The structure of the data in the central database 10 will now be described with reference to FIGS. 3 to 48.

The data model is structured in an object-oriented manner although the data stored in the central database 10 can be stored as a relational database comprising related tables. The object oriented data model is implemented by the application running on the web servers 12a and 12b to allow for the independent modification of objects in the data model. Thus the application logic operates in accordance with the data model to generate SQL queries to the database servers 11a and 11b for the creation of and accessing of the data in the central database 10.

The class of objects created in the data model include:
i) Employees defines data on persons who are the subject of the substance abuse tests. Such people can include prisoners, detainees, probationers, parolees, etc. The definition allows a user to define the name to be given to the person in the central database 10. For example, a user may wish to define such people as customers or clients for example.
ii) Exams defines data on the substance abuse test results for tests performed on the persons.
iii) Clients defines data on entities implementing substance abuse programs who wish to benefit from the centralized processing of the substance abuse data. The entities can comprise institutions, drug courts, parole boards, probation boards or an authority responsible for any of these.
iv) Users defines data on users of the system. Such users are associated with Clients.
v) Products defines data on the different components or modules of the system to which Clients can gain access.
vi) Jobs defines data on batches of substance abuse test results that are to be processed together.
vii) Locations defines data on the locations of Clients.
viii) Reports defines data on reports to be generated.

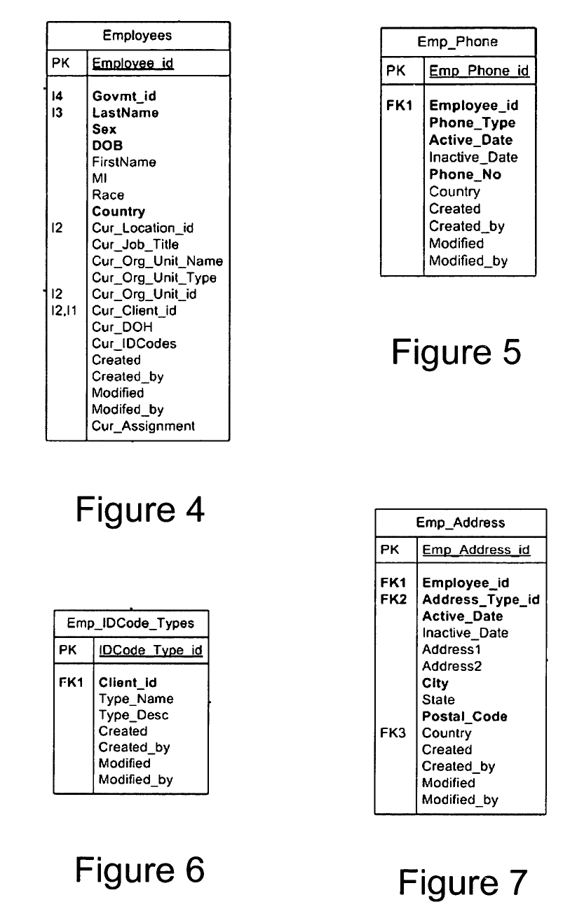

FIG. 3 illustrates the relationship of the tables in the data model. FIGS. 4 to 48 illustrate the tables individually in detail.

The Employees table illustrated in FIG. 4 stores data on the persons (termed ‘employees’) subject to the substance abuse tests including an ID for the person, name, sex, date of birth, race, and nationality. For the embodiment described with reference to FIG. 2, this table can also store biometric information of the person or a link to a storage location for the biometric information. The table also includes links to other tables to include information on the location of the person, the organisation unit, name, type and ID, and a client ID. Creation and modification data is also stored in the table. Thus a table record is kept for each person.

FIG. 5 illustrates the Emp_Phone table, which is linked to the Employees table and contains telephone number information for persons.

FIG. 6 illustrates the table Emp_IDCode_Types table, which contains data linked to clients describing the types of codes used by Clients to identify Employees.

FIG. 7 illustrates the Emp_Address table, which stores address information for the employees (i.e. persons). The address types can be work, home, and other addresses of the employees and these types are defined in the lk_Address_Type table.

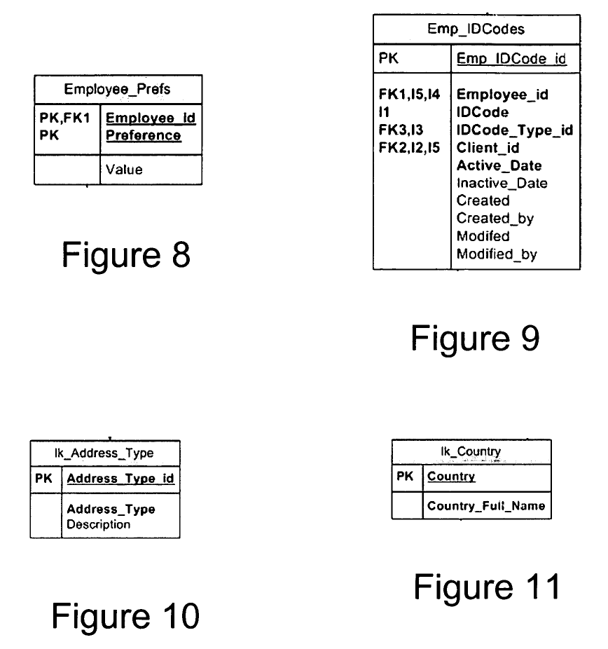

FIG. 8 illustrates the Employee_Prefs table, which stores preference information for each employee.

FIG. 9 illustrates the Emp_IDCodes table, which stores different identifiers for each employee for each client. This is necessary where an employee i.e. a person subject to substance abuse testing has a substance abuse test history for a number of entities. Each entity can use its own identification code for the persons for which they have jurisdiction responsibility. These different identification codes must be linked together to enable the aggregation of the substance abuse history for the person.

FIG. 10 illustrates the lk_Address_Type table, which stores information on employee address types e.g. home, work, relatives, etc.

FIG. 11 illustrates the lk_Country table, which contains information on the countries for the employees' addresses.

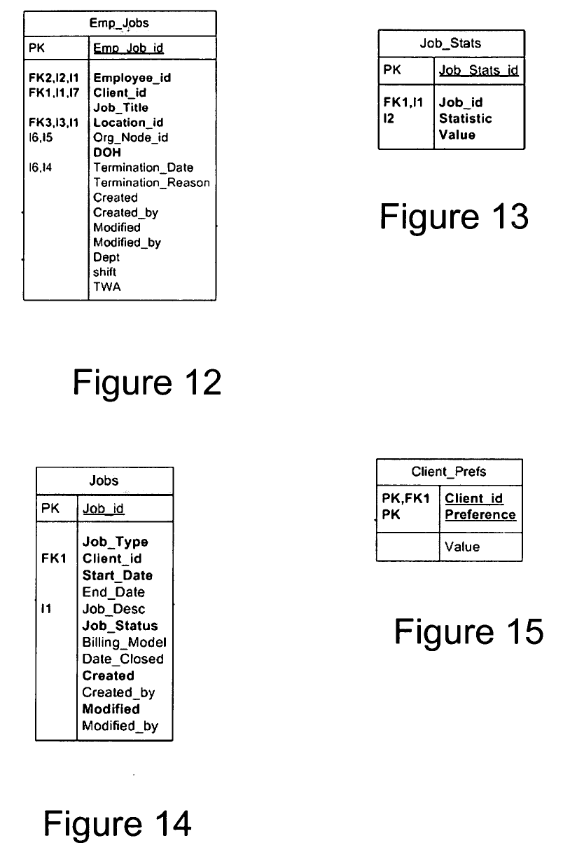

FIG. 12 illustrates the Emp_Jobs table, which stores current and historical information on assignments for each employee. An assignment includes the type of assignment represented as well as the start and end dates and position in the client's organisation hierarchy to which the employee is assigned.

FIG. 13 illustrates the Job_Stats table, which stores statistical records about a particular job.

FIG. 14 illustrates the Jobs table, which stores information about batches of substance abuse test results i.e. exams, which comprise a job for clients.

FIG. 15 illustrates the Client_Prefs table, which stores customer specific data used by the Central Drug Management System 1. For example the data can include specific logo information to be inserted in the web page user interface, welcome screen text and what to call “employees” e.g. inmates, prisoners, or clients.

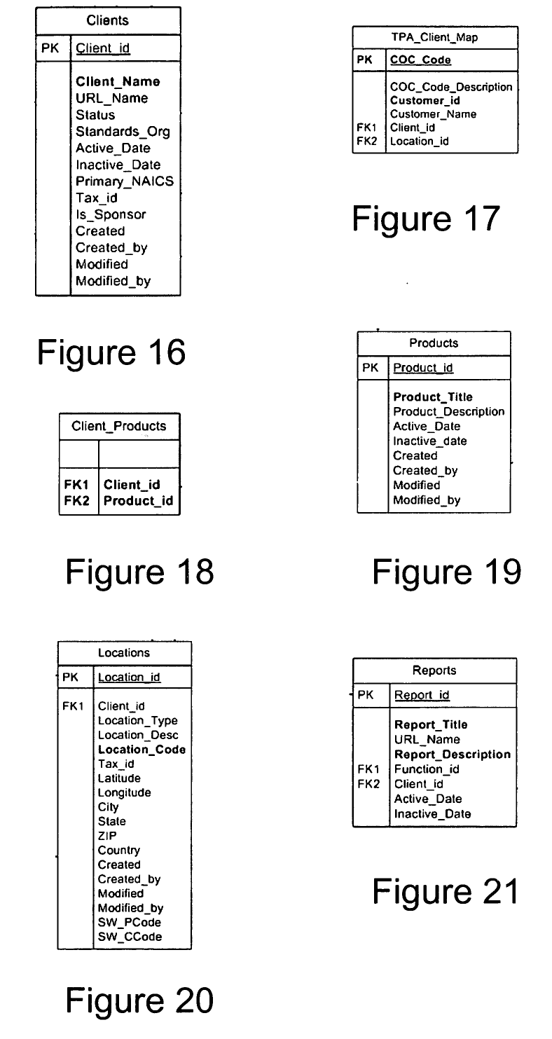

FIG. 16 illustrates the Clients table, which stores main details for entities wishing to utilise the Central Drug Management System 1. The clients can comprise individual institutions, parole boards, probation authorities, or drug courts, or they can comprise authorities responsible for any number or combination of these.

FIG. 17 illustrates the TPA_Client_Map table, which is used to map data between legacy data systems and the central database of the Central Drug Management System 1.

FIG. 18 illustrates the Client_Products table, which links clients to products.

FIG. 19 illustrates the Products table, which provides information on the components or modules available in the Central Drug Management System.

FIG. 20 illustrates the Locations table, which provides information on geographic locations at which clients are located. The table contains the ID code for the client at the location, the type of location, the description of the location, a location code, and geographic information on the location. Where a client comprises an authority for which there are a number of institutions, a client will have associated with it a number of location codes.

FIG. 21 illustrates the Reports table, which contains information on reports that are required to be generated for clients. The table contains a report title, a URL for the report to enable the client to retrieve the report, a report description, a link to the ID of the client, a link to the function table for the report, and an indication of the active dates for the report.

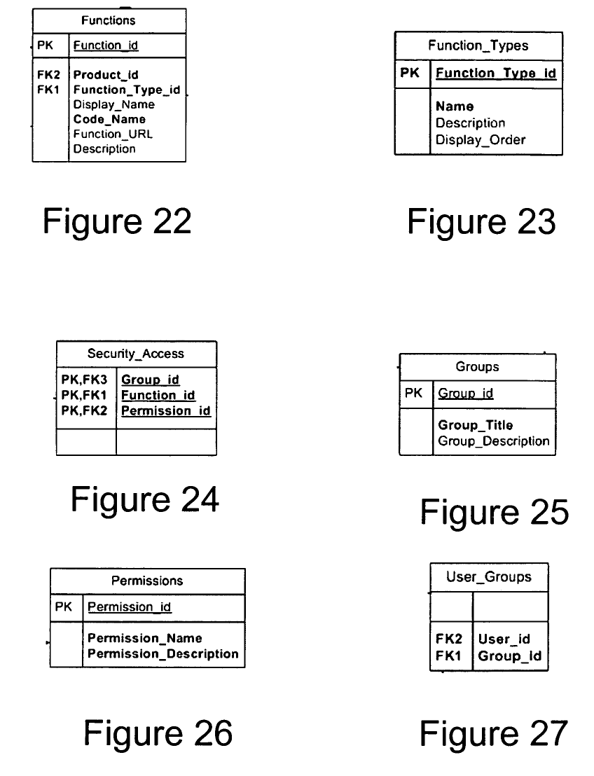

FIG. 22 illustrates the Functions table, which contains product ID to link to a particular product, and a function type ID. This table holds records that define the functionality of the website or provide links to other websites.

FIG. 23 illustrates the Function_Types table, which stores information on the types of functions that appear on the website as tabs on the homepage.

FIG. 24 illustrates the Security_Access table, which contains details defining which security groups have access to which functions.

FIG. 25 illustrates the Groups table, which identifies groups of users to provide for security access restrictions.

FIG. 26 illustrates the Permissions table, which stores different types of permissions that are used to control security access.

FIG. 27 illustrates the User_Groups table, which contains data identifying which users belong to which group. This table links the Groups table with the Users table.

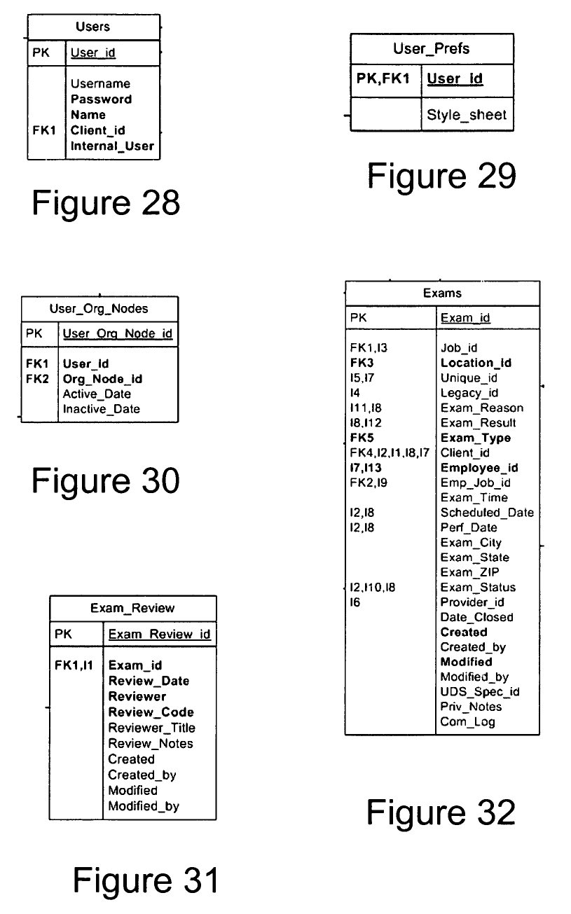

FIG. 28 illustrates the Users table, which stores information about users of the Central Drug Management System 1. The table contains information on the user and links to the client to which the user is related. Users can for example be prison officers, parole board members, or officers of the court.

FIG. 29 illustrates the User_Prefs table, which stores preference information for users of the Central Drug Management System 1. The User_Prefs table is linked to the Users table.

FIG. 30 illustrates the User_Org_Nodes table, which defines a top node in the client's organisation tree to which a particular user has access. The table thus stores the ID of the top node together with the ID of the user.

FIG. 31 illustrates the Exam_Review table, which stores comments and notes relating to a particular exam. The notes and comments are made by a reviewer who is identified by a review code.

FIG. 32 illustrates the Exams table, which stores the basic information about an exam i.e. a substance abuse test result, including who it was for, when it was performed, for what reason, at what location, the result, and the exam type. In the embodiment described with reference to FIG. 2, the Exams table can also store information obtained surrounding the taking of the instant test. The data can either be stored directly in the database, or links to image files can be stored in the database and the image files can be stored elsewhere. The test results can comprise two types: laboratory tests and instant tests. The reason for the test can be a random test, a voluntary test, a for cause test (when the authorities have a reason to take a test) or a retest.

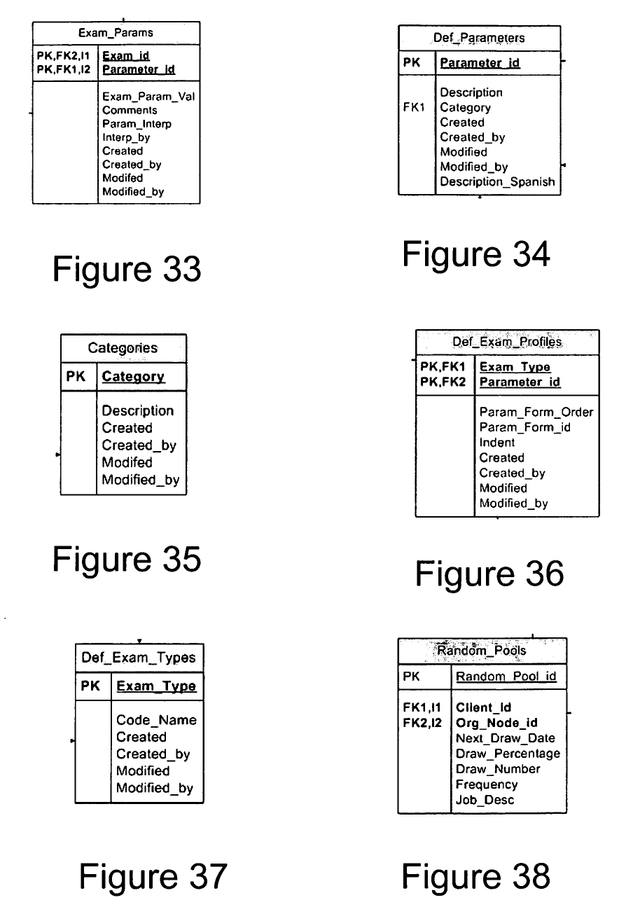

FIG. 33 illustrates the Exam_Params table, which stores the values of the different parameters for a particular exam.

FIG. 34 illustrates the Def_Parameters table, which stores the individual parameters of various categories that make up the details of an Exam.

FIG. 35 illustrates the Categories table which stores information on the categories of parameters used in conjunction with the different Exam types.

FIG. 36 illustrates the Def_Exam_Profiles table, which stores definitions of which parameters are part of each Exam type.

FIG. 37 illustrates the Def_Exam_Types table, which identifies the different types of Exams.

FIG. 38 illustrates the Random_Pools table, which identifies the top nodes in the client's organisation tree that are used to form pools of employees from which random draws are selected.

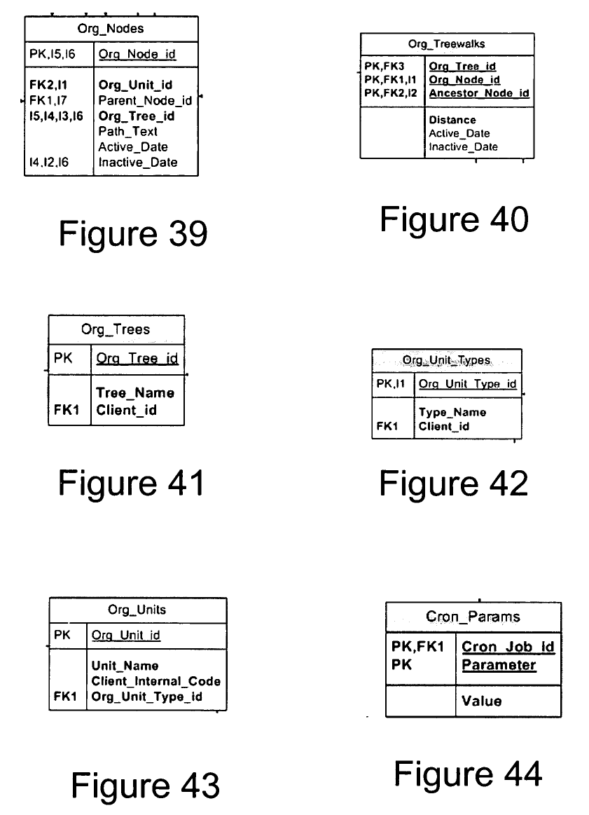

FIG. 39 illustrates the Org_Nodes table, which defines the individual nodes in a client's hierarchical organisation.

FIG. 40 illustrates the Org_Treewalks table, which holds the relationships between nodes in the client's hierarchical organisation.

FIG. 41 illustrates the Org_Trees table, which contains the basic details of the client's organisational structure.

FIG. 42 illustrates the Org_Unit_Types table, which holds information on the different types of organisational units used by clients.

FIG. 43 illustrates the Org_Units table, which stores the details of the particular organisational units that make up each client's organisational structure.

FIG. 44 illustrates the Cron_Params table, which stores parameters for backend system tasks.

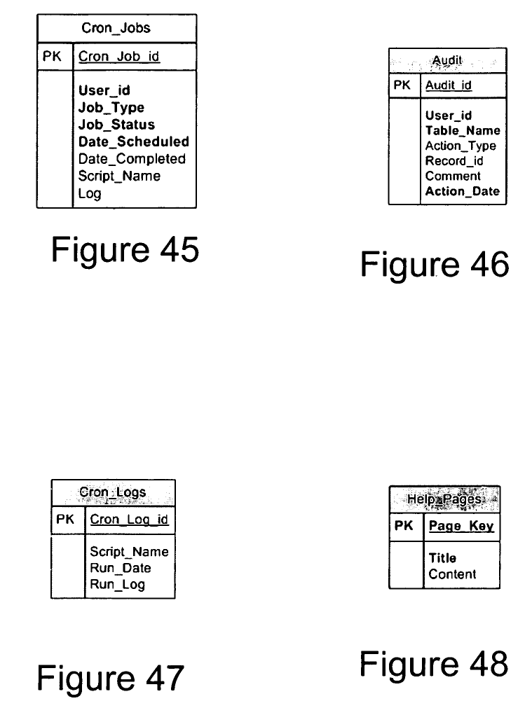

FIG. 45 illustrates the Cron_Jobs table, which holds details of system tasks that run behind the scenes.

FIG. 46 illustrates the Audit table, which maintains information regarding changes in the database.

FIG. 47 illustrates the Cron_Logs table, which stores the results log files of backend system tasks for reporting to users.

FIG. 48 illustrates the Help_Pages tables, which stores context sensitive help pages for the users.

It can be seen from FIGS. 3 to 48 that the parameters are stored in the database in tables defining the object structures. The data is thus organised as objects. The hierarchical organisation of the clients is modelled in the data structure. The use of the object model provides for a flexible data structure that can be amended and updated to adapt to changes in the organisational structure of the clients. The organisational structures that are modelled in the data model are the jurisdictional and custodial structure. An entity having jurisdictional responsibility can be jurisdictionally responsible for administration and for physical locations. The administration encompasses a number of officials who have custodial responsibility for persons. Such officials can comprise prison officers, parole board members, or court officials for example. The persons can comprise inmates, parolees, or probationers for example. The officials form an administrative hierarchy in which officials at different levels of the hierarchy have different levels of responsibility and therefore different levels of security access to information and functions in the central drugs management system 1. The system thus has to map security to each user, where the users comprise the officials. The physical locations comprise the locations under the jurisdiction of the entities and include locations at which the persons are detained e.g. institutions including prisons, detention centres, police cells etc. The locations information is hierarchically organised. For example a location can comprise an institution, broken down into wings. Each wing is broken down into individual rooms. Each room is broken down into individual beds in the room. At each location persons are mapped to the location. Also the officials having custodial responsibility are mapped to the physical location so that the officials become part of two hierarchical structures, one being administrative to show personnel custodial responsibility and the other being location to show location custodial responsibility. The database thus allows the mapping between these structures and the object oriented data model provides the flexibility to allow for the modification of the hierarchical structures. The access control security built into the data model allows users to carry out certain modifications as defined in the data model. The modifications can be to the data parameters and even to the hierarchical structures for hierarchical levels beneath them which they are allowed to control. Users are permitted to manage the hierarchy, the content of the database i.e. the parameters, security for security levels below their own, substance abuse programs, and report generation as will be described in more detail herein after.

Clients have their own hierarchical structures. Users of the system are assigned nodes in the hierarchical system. Persons (employees) are also assigned to nodes in the hierarchical structures. Users will have access to all employees that are assigned to nodes that fall under their nodes in the organisational structures. This relates all of the persons for whom the users have custodial responsibility.

In one embodiment, institutions have a five-level organizational structure. Users in the Commissioner's Office will be assigned to the root of the tree, and will have access to all Employee (prisoner) data. The first level down in the hierarchy is the Institution. Users in the Warden's Office of each Institution will be assigned to the appropriate node at this level of the tree. Below this level, the levels describe the location in the facility that each prisoner inhabits. Employees will most likely be assigned to the “Wing” level. The level structure is thus:
Root
   Institution
      Unit
         Area
         Wing

In this embodiment, a Probation and Parole system has a four-level organizational structure. The Users in the General Manager's office will be assigned to the root node of the tree. The first level down is the District. Users in the General Supervisors' offices will be assigned to the appropriate nodes in this level of the org tree. One level below that will be the Probation Offices. Users that are Office Supervisors will be assigned to this level. The lowest level is the Parole Officers themselves. Officer Users will be assigned to their own node, and all Parolees will be assigned to their appropriate Officer node. The level structure is thus:
Root
   District
      Office
         Officer

In this embodiment, an Administrative Office of the Courts (AOC) system has a four level hierarchy which is primarily for reporting purposes rather than a permissions structure. The AOC managers will have access to the entire tree, while individual case workers and judges will only have access to their courts or counties. The counties list is divided into a two-level structure by letter. The first level of the hierarchy is the first letter of the counties represented; the next level is the counties themselves. Finally, the individual drug courts appear under the county they are a part of. The level structure is thus:
Root
   Counties (A-Z)
      County
         Court

The data model provides for the management and tracking of persons through a number of custodial environments. The data model also provides for the management and tracking of officials at different custodial environments. Each entity such as an authority or institution can have disparate systems but with communication to the central drug management system 1, the data is aggregated and processed to allow for the comparison of the effectiveness of substance abuse programs, the comparison of the results of substance abuse programs for entities, and the standardisation of substance abuse programs for different entities.

The database can centralise the substance abuse data for authorities at any level e.g. county, state, or country and it allows for the comparison on substance abuse programs at any level of the hierarchical tree of jurisdictional responsibility.

The database can include not just data on the outcome of tests, but also data on the effect of failure of the test e.g. the penalty to be applied to the person.

The database includes tables used in the generation of a random testing program as a part of the substance abuse program. The application running on the web servers 12a and 12b can use the data to implement an algorithm to determine a random test program for the persons that are the jurisdictional responsibility of an entity. The algorithm will automatically select persons for testing. The algorithm can also process the previous results to identify substances to test for based on abuse detection rates for the substances. The algorithm can also select the product to be used for the test program. The randomness of the program can be weighted based on previous results to take into account abuse detection history for locations or for groups of individuals for example. The algorithm can also set regular testing programs by taking the abuse detection history into account.

The reports table in the data model enables reports on the data in the central database 10 to be generated in a tailored fashion. Users are able to define the reports that they require. The reports can comprise individual reports for individuals together with reports on processed results for one or any number of entities. Thus reports on the drug histories for individuals can be produced. For a group of individuals statistical results can be provided showing the number of positive and negative results. The data can be processed for groups of persons based on demographics, location, jurisdictional entity, drug or drug type. The reports can provide information on trends for drugs, products used for testing, demographics, location, or jurisdictional entity for example. The reports can show the statistics which facilitates the management of substance abuse programs. The reports enable the cost and effectiveness of programs to be reviewed and compared. For example the costs of tests are recorded and this in conjunction with detection rates can be an indicator of the effectiveness of the program. Of course, the data has to be treated carefully since other factors such as a global increase in substance abuse could account for an increased detection rate. The centralised system enables the formation of standardised substance abuse programs for a number of entities having jurisdictional responsibility. Thus institutions of different types can adopt the same standard program based on the centralised management system. The reports also enable recidivism rates for individuals, groups of individuals, locations, institutions and a number of entities or institutions to be viewed as a further indicator of the effectiveness of a substance abuse program and to compare the effectiveness of individual substance abuse programs.

Users of the central drug management system 1 interface with the system using a web browser to view web pages. These pages are either static pages, such as the initial login page, or dynamically generated pages which are dynamically generated by the applications in the web servers 12a and 12b using data in the central database 10. The Pages are dynamically generated to include the required data and to be tailored to the user's requirement using user preference data. For example, an institution may want their logo to appear on the web page and they may wish to call their inmates ‘clients’. This information is stored in the tables in the central database 10 and used by the applications to personalise the web pages.

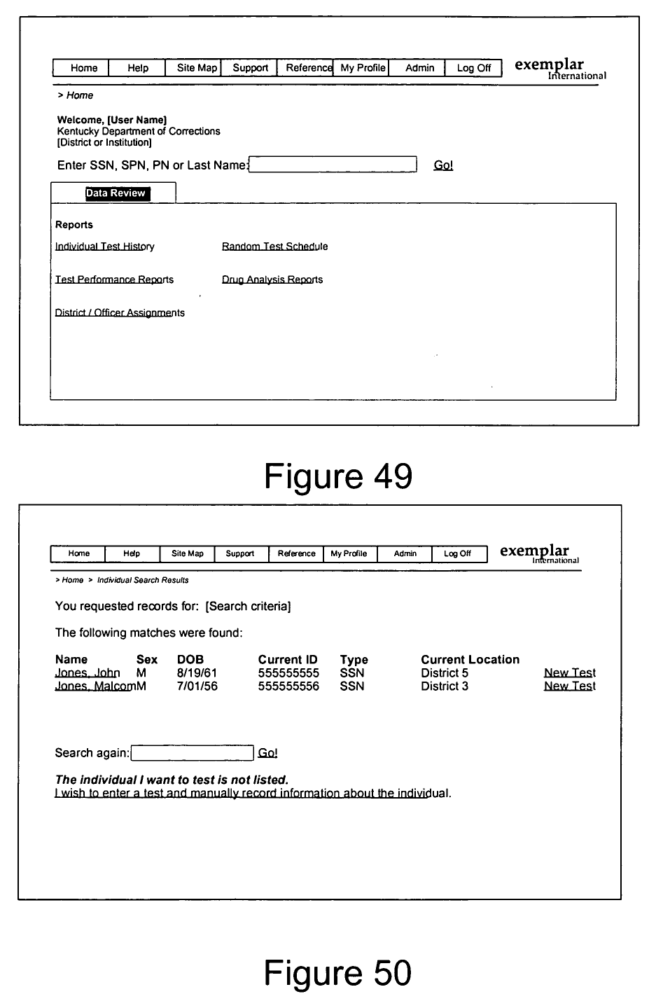

FIG. 49 illustrates an example home page for a user and is a launching point for all functions and reports. The user can enter an inmate code, which in this example comprises one of a number of institution specific codes termed SSN, SPN, or PN. Alternatively a user can enter the inmate's last name to search for test results for them. A user can also select to view an individual test history for an inmate, a test performance report, a random test schedule, a drug analysis report, or a district/officer assignments report.

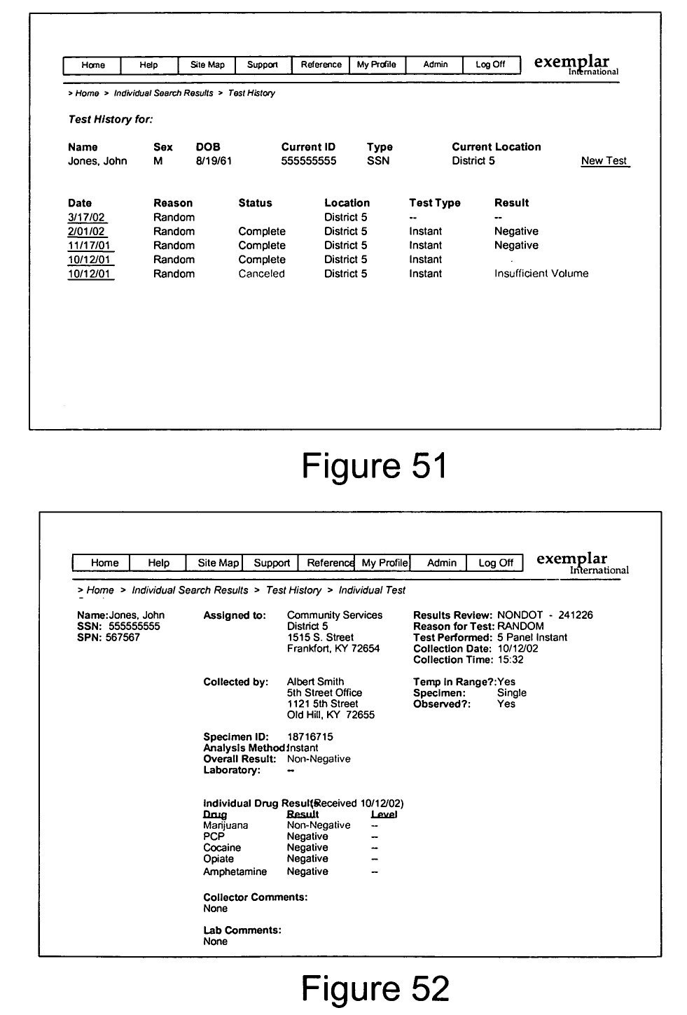

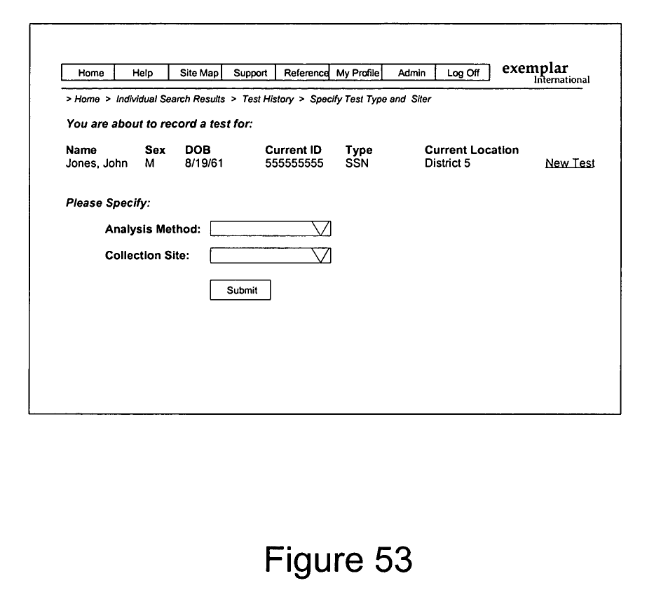

FIG. 50 illustrates the web page for a user selection for the input search surname Jones in FIG. 49. There are ‘name’ links provided to the web page of FIG. 51. The page shows information on two persons to allow a user to select the name link for the desired person. A ‘New Test’ link is provided for each person to allow a user to select to enter new test data for a person by going to the page illustrated in FIG. 53. Also a user can use the search field at the bottom of the page to perform the same search as for FIG. 49 again. If a user cannot find a person, they can select the ‘I wish to enter a test and manually record information about the individual’ link to take them straight to the page illustrated in FIG. 53.

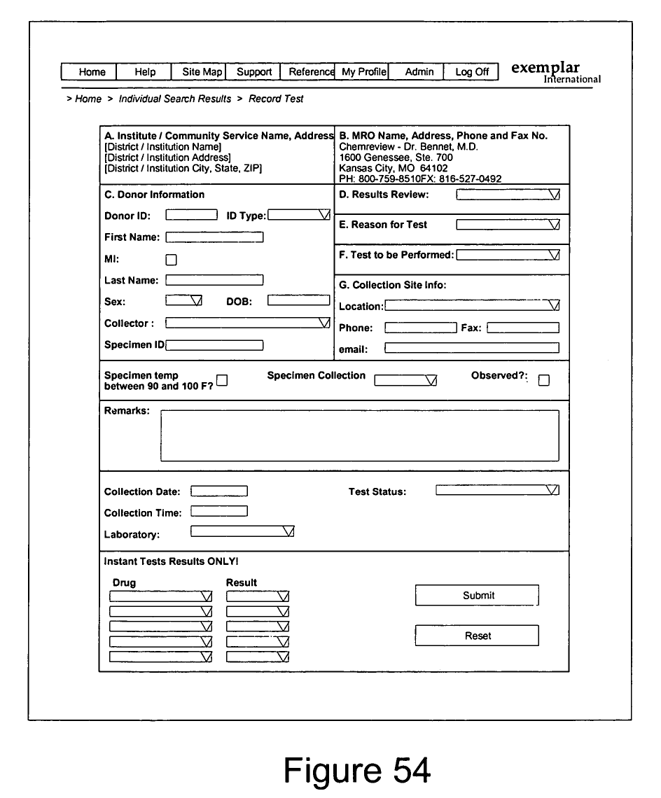

FIG. 51 illustrates all recorded tests for an individual and where/when that test was performed. Scheduled random tests not yet performed are highlighted. Non-negative or positive test results are also highlighted. If a particular test is completed, the ‘Test Date’ link will point to the page of FIG. 52 and displays data about their test. If the test is a scheduled random that has not yet been performed, the link points to the page of FIG. 54, with the name and random test information already filled in. The ‘New Test’ link points to the page of FIG. 53 and allows the user to create a new test for this individual.

FIG. 52 illustrates detailed information about the drug test performed. The user cannot edit this information.

FIG. 53 illustrates the first step in recording a drug test. The user selects the analysis method and collection site for the test. The ‘Analysis Method’ dropdown displays the various analysis methods available (5-panel lab, instant, etc). The ‘Collection Site’ dropdown displays the available collection sites; this list is limited to the district/institution associated with the user. The ‘Submit’ button takes the user to the page of FIG. 54.

FIG. 54 illustrates the main form used for recording test information. If this page is the result of clicking ‘New Test’ associated with an individual, the donor information will already be filled out. The district/institution information is automatically assigned based on the user's profile. The drugs and results input boxes appear only if the analysis method selected in the page of FIG. 53 is an instant test method. The ‘Submit’ button records the test and displays the page of FIG. 52 with the recorded data. The input fields are:
Donor ID: PN, SPN, SSN of the donor
ID Type: Indicates whether the number is a PN, SPN, or SSN.
First Name, MI, Last Name: First name, middle initial and last name of donor.
Sex, DOB: Sex and date of birth of donor
Collector: Name of individual performing collection.
Specimen ID: Lab or instant kit specimen ID for sample.
Results Review: The analysis method (panel and method) used for the test.
Reason for Test: Random or Cause

Test to be Performed:
Location: The actual collection site, selected from available locations associated with user's institution/district
Phone: Phone number of collection site
Fax: Fax number of collection site
Email: email address for collector
Specimen temp . . . : Check box to indicate specimen temperature was in acceptable range
Specimen collection: Type of UDS specimen collected; Single or Split
Observed: Check box to indicate if test was observed
Collection Date: Date the sample was collected
Collection Time: Time the sample was collected (military format)
Laboratory: Laboratory analyzing sample
Test Status: Status of test—Pending, Complete or Not Performed
Drug/Result: Fields to allow recording of specific drug results for instant tests only

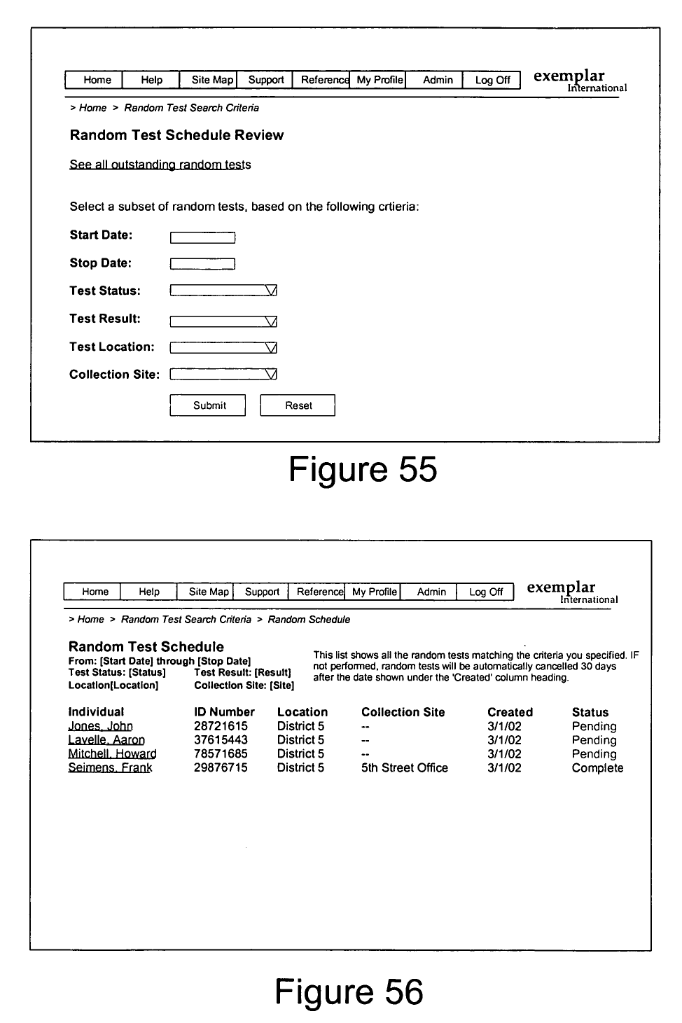

FIG. 55 illustrates the search screen, which allows the user to specify criteria for random tests to be displayed. The ‘Submit’ button displays the page of FIG. 56, using the criteria specified by the user. The ‘See all outstanding . . . ’ link points to the page of FIG. 56, showing all tests with a ‘Pending’ status in the user's district/institution; the user does not have to complete the fields below.

FIG. 56 illustrates a page showing all the random tests meeting the user-specified criteria. If the test status is ‘Complete’ or ‘Not Performed’, the ‘Individual’ link points to the page of FIG. 52 for the test detail. If the test status is ‘Pending’, the link points to the page of FIG. 54, with predefined test information to allow the user to record test information.

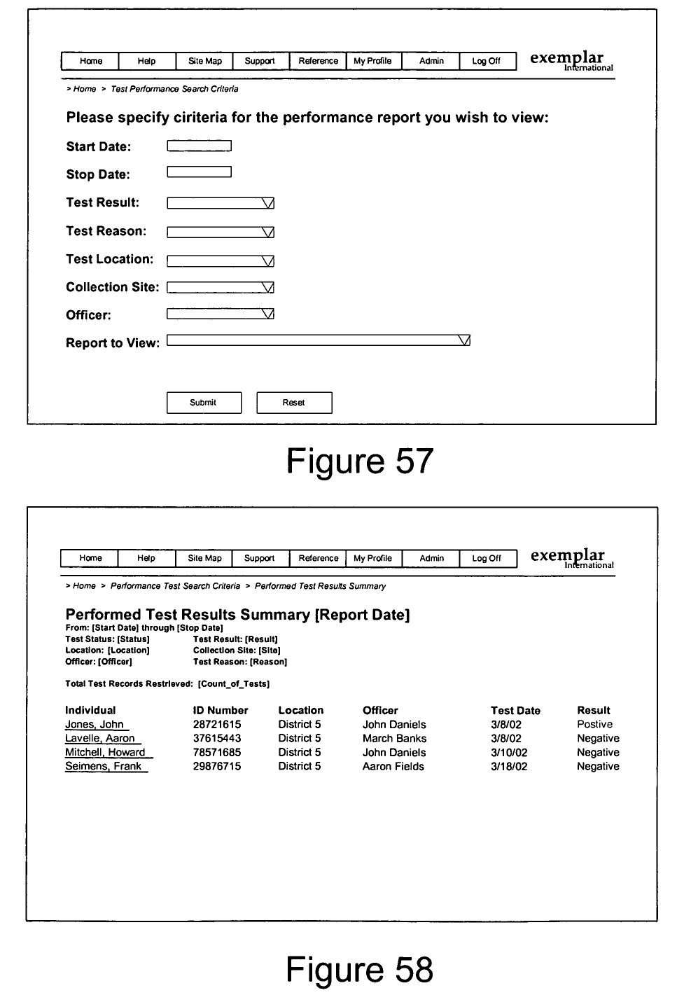

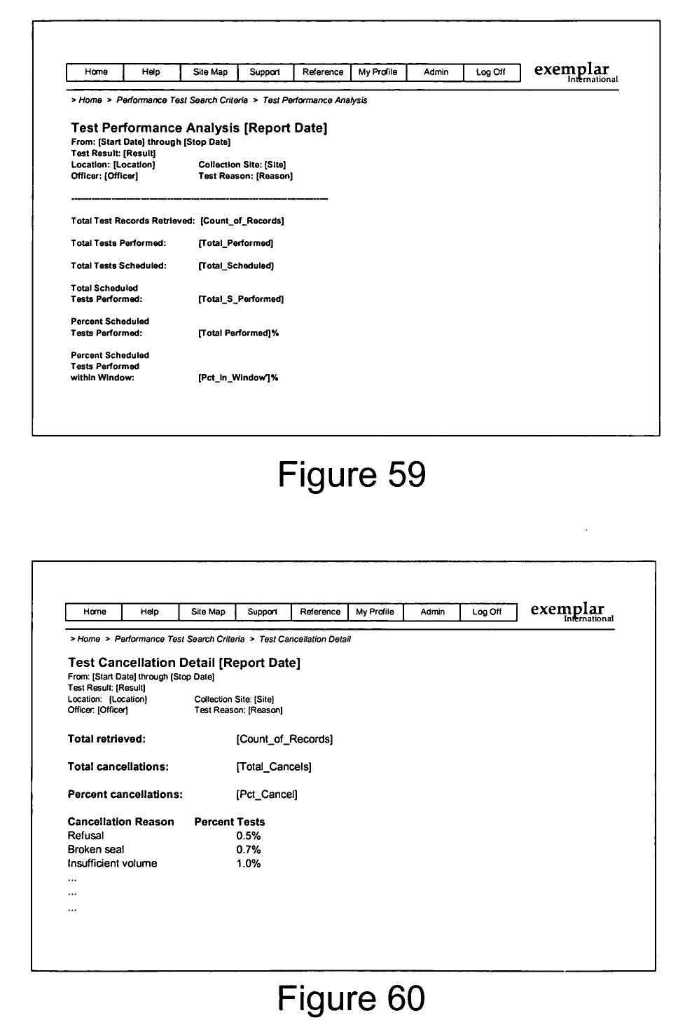

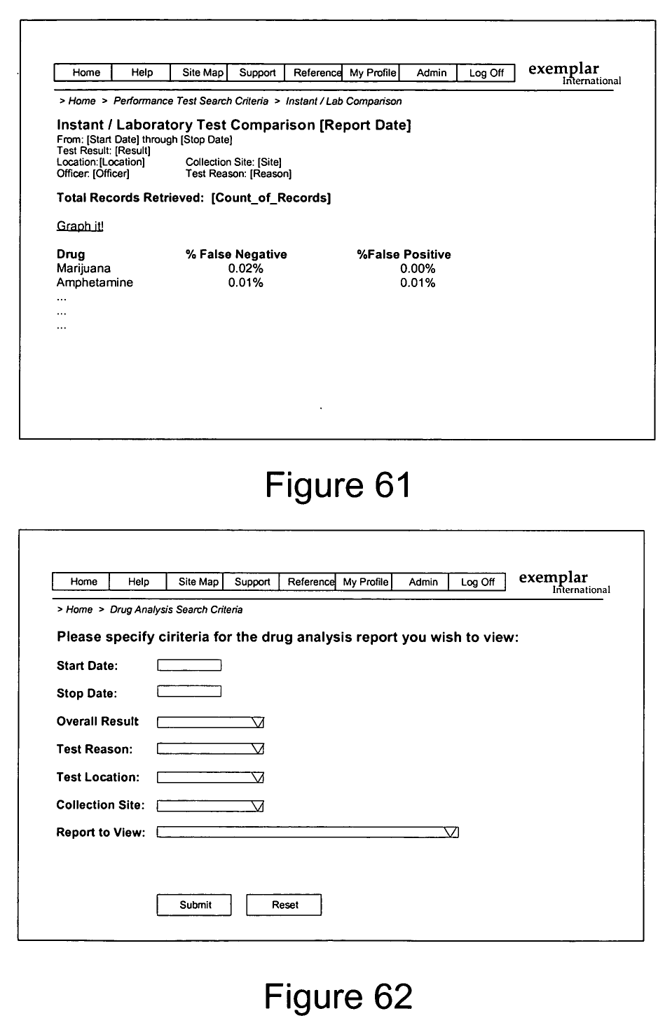

FIG. 57 illustrates a page showing a search screen allowing the user to specify criteria for performance reports. The locations, collections sites, and officers available in the dropdowns will depend on the user's account. Any or all of the input fields may be changed. This allows the same search screen and reports to display reports for the whole state, a district or institution, a collection site, or even an officer. The ‘Submit’ button can take the user to four different screens, depending on what's selected in the ‘Report to View’ dropdown. ‘Performed Test Summary’ points to the page illustrated in FIG. 58; ‘Performance Analysis’ points to the page illustrated in FIG. 59; ‘Cancellation Detail’ points to the page illustrated in FIG. 60; and ‘Instant/Laboratory Test Comparison’ points to the page illustrated in FIG. 61.

FIG. 58 illustrates a page showing a list of all tests meeting the search criteria from the page illustrated in FIG. 57. The ‘Individual’ link points to the page illustrated in FIG. 52 which shows the test detail record for the selected test.

FIG. 59 illustrates a page showing summary statistics regarding the number of tests performed based on criteria specified in the page illustrated in FIG. 57.

FIG. 60 illustrates a page showing summary cancellation statistics for tests meeting the criteria specified in the page illustrated in FIG. 57.

FIG. 61 illustrates a page showing the percentages of tests (per drug) where laboratory analysis does not confirm the instant test results. A ‘False Negative occurs when an instant test shows negative but the lab shows positive. A ‘False Positive’ occurs when an instant test shows non-negative, but the lab shows negative. The ‘Graph it!’ link displays a bar chart of the data displayed.

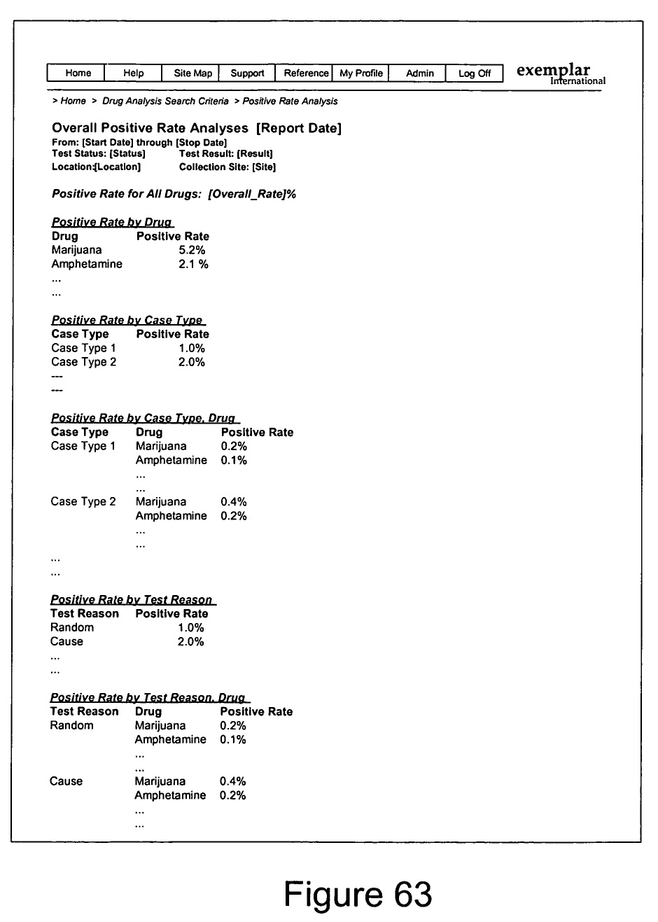

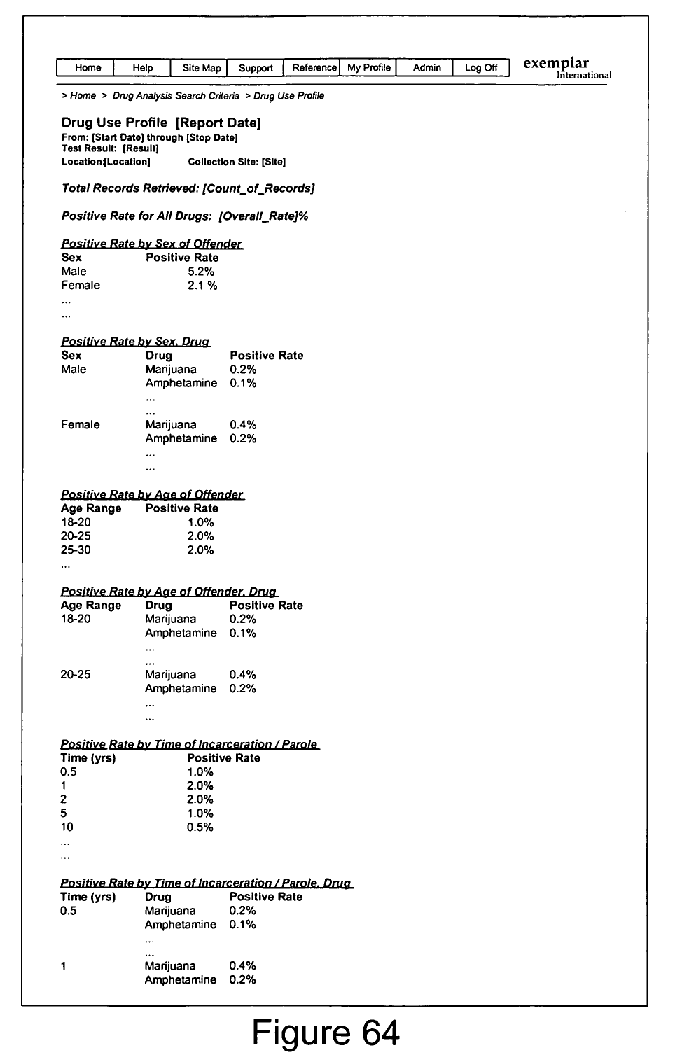

FIG. 62 illustrates a page, which allows the user to specify criteria for displaying statistical reports related to drug user patterns. The ‘Submit’ button takes the user to one of two screens, depending on the ‘Report to View’ selected: ‘Positive Rate Analysis’ points to the page illustrated in FIG. 63, while ‘Drug Use Analysis’ points to the page illustrated in FIG. 64.

FIG. 63 illustrates a page showing a report, which is actually several reports presents on a single page, showing various views of positive rates. The section headers are links to bar or pie graphs of the data shown.

FIG. 64 illustrates a page showing a report, which is actually comprised of several reports presented on the same page, showing various views of data showing positive test data related to individuals. The section headers are links to bar or pie graphs of the data shown.

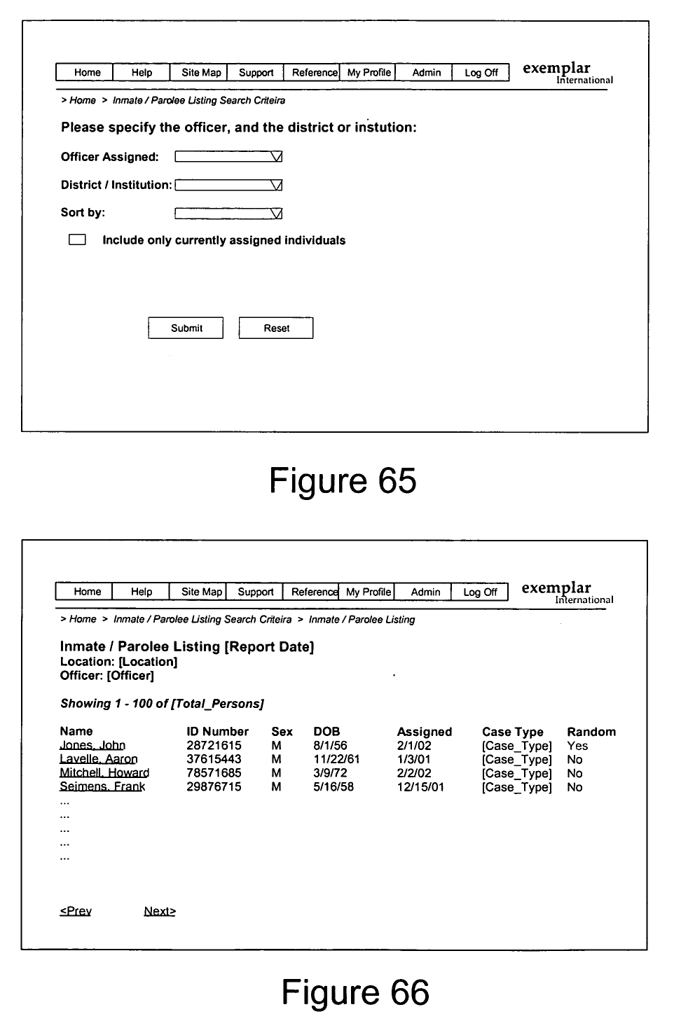

FIG. 65 illustrates a page that allows the user to specify search criteria in order to display a list of inmates/parolees associated to a particular officer. If the ‘Include only currently assigned individuals’ check-box is selected, only current assignments are shown. Otherwise the search will return all individuals ever assigned to the officer specified.

FIG. 66 illustrates a page showing a list of all individuals assigned to an officer, based on criteria specified in the page illustrated in FIG. 65. The ‘Random’ field is highlighted if the individual has a pending random test. The ‘Name’ link points to the page illustrated in FIG. 51, which displays the test history for the specified individual.

Thus the interface provided to the central drug management system 1 allows a user to access various reports as well as manipulate the organisational structure of the client.

Although the present invention has been described with reference to specific embodiment, it will be apparent to a skilled person in the art that modifications lie within the spirit and scope of the present invention.

1. A method of managing correctional and/or rehabilitation programs for substance abuse for a number of entities having jurisdictional responsibility for persons, the method comprising:
receiving correctional and/or rehabilitation data from a plurality of entities having jurisdictional responsibility for persons, said correctional and/or rehabilitation data including information on substance abuse by persons for which said entities have jurisdictional responsibility;
processing the received correctional and/or rehabilitation data to aggregate the data and reference the data by each entity to allow for comparative analysis of the correctional and/or rehabilitation programs;
storing the processed correctional and/or rehabilitation data in a central database; and
managing the correctional and/or rehabilitation programs dependant upon the processed data.

2. A method according to claim 1, wherein the correctional and/or rehabilitation programs are managed to standardise the programs for the entities.

3. A method according to claim 1, wherein the management of the program includes determining what drug to test for and when to test based on the processing.

4. A method according to claim 1, wherein the management of the program includes identifying a group of persons and determining what drug to test for and when to test based on the processing.

5. A method according to claim 1, wherein the management of the program includes identifying a group of persons to test based on the processing.

6. A method according to claim 1, wherein the processing includes processing the received correctional and/or rehabilitation data to determine recidivism rates for persons.

7. A method according to claim 1, wherein the management of the program includes determining random drug test programs.

8. A method according to claim 1, wherein the database stores a test history for each person, indexed by entity.

9. A method according to claim 8, wherein said test history for each person includes information on current entity having jurisdictional responsibility and any previous entities having jurisdictional responsibility.

10. A method according to claim 1, wherein the management of the correctional and/or rehabilitation programs includes identifying the substance to test for and the equipment to use for the test.

11. A method according to claim 1, wherein the entities having jurisdictional responsibility are organised in at least one hierarchy and the data is stored in the database in a jurisdictional hierarchical structure.

12. A method according to claim 1, wherein the management of the correctional and/or rehabilitation programs includes generating reports on the processed correctional and/or rehabilitation data.

13. A method according to claim 1, wherein the management of the correctional and/or rehabilitation programs includes performing statistical analysis on the processed correctional and/or rehabilitation data.

14. A method according to claim 1, wherein said entities include at least one of: individual or groups of correctional institutions, individual or groups of parole authorities, individual or groups of probation authorities, individual or groups of courts, and police.

15. A method according to claim 1, wherein said persons include at least one of: correctional institution inmates, parolees, remanded persons, probationers, and detainees.

16. Apparatus for managing correctional and/or rehabilitation programs for substance abuse for a number of entities having jurisdictional responsibility for persons, the apparatus comprising:
receiving means for correctional and/or rehabilitation data from a plurality of entities having jurisdictional responsibility for persons, said correctional and/or rehabilitation data including information on substance abuse by persons for which said entities have jurisdictional responsibility;
processing means for processing the received correctional and/or rehabilitation data to aggregate the data and reference the data by each entity to allow for comparative analysis of the correctional and/or rehabilitation programs;
a storage arrangement for storing the processed correctional and/or rehabilitation data in a central database; and
management means to manage the correctional and/or rehabilitation programs dependant upon the processed data.

17. Apparatus according to claim 16, wherein the management means determines standard correctional and/or rehabilitation programs for the entities.

18. Apparatus according to claim 16, wherein the management means includes means for determining what drug to test for and when to test based on the processing.

19. Apparatus according to claim 16, wherein the management means includes means for identifying a group of persons and determining what drug to test for and when to test based on the processing.

20. Apparatus according to claim 16, wherein the management means includes means for identifying a group of clients to test based on the processing.

21. Apparatus according to claim 16, wherein the processing means includes means for processing the storing the received correctional and/or rehabilitation data to determine recidivism rates for persons.

22. Apparatus according to claim 16, wherein the management means includes means for determining random drug test programs.

23. Apparatus according to claim 16, wherein the database stores a test history for each person, indexed by entity.

24. Apparatus according to claim 23, wherein said test history for each person includes information on current entity having jurisdictional responsibility and any previous entities having jurisdictional responsibility.

25. Apparatus according to claim 16, wherein the management means includes means for identifying the substance to test for and the equipment to use for the test.

26. Apparatus according to claim 16, wherein the entities having jurisdictional responsibility are organised in at least one hierarchy and the data is stored in the database in a jurisdictional hierarchical structure.

27. Apparatus according to claim 16, wherein the management means includes means for generating reports on the processed correctional and/or rehabilitation data.

28. Apparatus according to claim 16, wherein the management means includes means for performing statistical analysis on the processed correctional and/or rehabilitation data.

29. Apparatus according to claim 16, wherein said entities include at least one of: individual or groups of correctional institutions, individual or groups of parole authorities, individual or groups of probation authorities, individual or groups of courts, and police.

30. Apparatus according to claim 16, wherein said persons include at least one of: correctional institution inmates, parolees, remanded persons, probationers, and detainees.

31. A method of forming a chain of custody record for instant drug tests for persons, the method comprising:
obtaining point-of-test information at times instant drug tests are taken, the point-of-test information including information on the circumstances surrounding the taking of a drug test;
obtaining results of the instant drug tests; and
storing the point-of-test information in conjunction with the results to provide a chain of custody record for the instant drug test for each person.

32. A method according to claim 31, including obtaining a biometric measurement from each person at the time the instant drug test is performed, wherein the point-of-test information for each person includes the biometric information obtained from the person.

33. A method according to claim 31, wherein the point-of-test information for each person includes information on the test equipment, information on the tester, information on the test environment, and test location, date and time information.

34. A method according to claim 33, including obtaining a biometric measurement from each person at the time the instant drug test is performed, wherein the point-of-test information for each person includes the biometric information obtained from the person.

35. A method according to claim 33, including obtaining image information for the test, wherein said information on the test environment includes the image information for the test.

36. A method according to claim 35, wherein the image information comprises a still or motion image of the test equipment showing the test result and the tested person in the test environment.

37. A method according to claim 34, including obtaining image information for the test, wherein said information on the test environment includes the image information for the test.

38. A method according to claim 37, wherein the image information comprises a still or motion image of the test equipment showing the test result and the tested person in the test environment.

39. Apparatus for forming a chain of custody record for instant drug tests for persons, the apparatus comprising:
means for receiving point-of-test information at times instant drug tests are taken, the point-of-test information including information on the circumstances surrounding the taking of a drug test;
means for receiving results of the instant drug tests; and
storage means for storing the point-of-test information in conjunction with the results to provide a chain of custody record for the instant drug test for each person.

40. Apparatus according to claim 39, including means for receiving a biometric measurement from each person at the time the instant drug test is performed, wherein the point-of-test information for each person includes the biometric information obtained from the person.

41. Apparatus according to claim 39, wherein the point-of-test information for each person includes information on the test equipment, information on the tester, information on the test environment, and test location, date and time information.

42. Apparatus according to claim 41, including means for receiving a biometric measurement from each person at the time the instant drug test is performed, wherein the point-of-test information for each person includes the biometric information obtained from the person.

43. Apparatus according to claim 41, including means for receiving image information for the test, wherein said information on the test environment includes the image information for the test.

44. Apparatus according to claim 43, wherein the image information comprises a still or motion image of the test equipment showing the test result and the tested person in the test environment.

45. Apparatus according to claim 42, including means for receiving image information for the test, wherein said information on the test environment includes the image information for the test.

46. Apparatus according to claim 45, wherein the image information comprises a still or motion image of the test equipment showing the test result and the tested person in the test environment.

47. A method of forming a chain of custody record for instant drug tests for persons, the method comprising:
recording test information at times instant drug tests are taken, the test information including information on test conditions;
recording results of the instant drug tests; and
storing the test information in association with the results to provide a chain of custody record for the instant drug test for each person.

48. Apparatus for recording test information for forming a chain of custody record for instant drug tests for persons, the apparatus comprising:
a camera component for taking still or motion pictures of the test conditions;
a biometric recorder component for taking a biometric measurement of the tested persons;
an input interface for the input of test information including test results;
a memory for storing the test information, the pictures and the biometric measurements as chain of custody record records; and
an output interface for transmitting the stored information to a remote computer apparatus for recordal of the chain of custody records.

49. Apparatus according to claim 48, wherein said apparatus is portable and includes a battery power supply.

50. Apparatus for forming a chain of custody record for instant drug tests for persons, the apparatus comprising:
a camera component for taking still or motion pictures of the test conditions at times instant drug tests are taken;
a biometric recorder component for taking biometric measurements of the tested persons;
an input interface for the input of test information including results of the instant drug tests; and
a storage device for storing the still or motion pictures, the biometric measurements, and the results to provide a chain of custody record for the instant drug test for each person.

51. A substance abuse management system comprising:
a database storing substance abuse data for a plurality of persons, the database storing substance abuse results data, data on persons, data on users of the system, and data on hierarchical relationships of the users; and
a database interface for allowing the input of data to and the output of data from the database, the database interface comprising code structured to operate in accordance with an object oriented data model in which data is represented as objects, said objects including substance abuse results objects defining information on substance abuse results for persons, person objects defining information on persons, users and/or location objects defining information on system users comprising custodians of said persons and/or information on custodial locations of said persons, and organisation objects defining information on at least one hierarchical relationship of said system users and/or locations of said persons, said at least one hierarchical relationship defining at least one custodial hierarchy for custodianship of said persons;
wherein said database interface code is structured to allow for the formation and management of said at least one hierarchical relationship to provide for the formation and management of said at least one custodial hierarchy for said persons.

52. A substance abuse management system according to claim 51, wherein said database interface code is structured to allow for the independent modification of any said object.

53. A substance abuse management system according to claim 51, wherein said database interface code is structured to allow for the formation and management of at least one further hierarchical relationship defining at least one jurisdictional hierarchy for jurisdictional responsibility for said users and said persons.

54. A substance abuse management method comprising:
storing substance abuse data for a plurality of persons in a database, the data comprising substance abuse results data, data on persons, data on users of the system, and data on hierarchical relationships of the users; and
forming a database interface to allow the input of data to and the output of data from the database using an object oriented data model in which data is represented as objects, said objects including substance abuse results objects defining information on substance abuse results for persons, person objects defining information on persons, users and/or location objects defining information on system users comprising custodians of said persons and/or information on custodial locations of said persons, and organisation objects defining information on at least one hierarchical relationship of said system users and/or locations of said persons, said at least one hierarchical relationship defining at least one custodial hierarchy for custodianship of said persons;
wherein said object oriented data model allows for the formation and management of said at least one hierarchical relationship to provide for the formation and management of said at least one custodial hierarchy for said persons.

55. A substance abuse management method according to claim 54, wherein said object oriented data model allows for the independent modification of any said object.

56. A substance abuse management method according to claim 54, wherein said object oriented data model allows for the formation and management of at least one further hierarchical relationship defining at least one jurisdictional hierarchy for jurisdictional responsibility for said users and said persons.

57. A carrier medium carrying computer readable code for controlling a computer to carry out the method of any one of claims 1, 31, 47 or 54.
